(19) United States
(12) Patent Application Publication
(10) Pub. No.: US 2007/0038632 A1
(43) Pub. Date: Feb. 15, 2007

(54) Time slot based calendar access control

(76) Inventor: G. Eric Engstrom, Kirkland, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/584,467

(22) Filed: Oct. 20, 2006

Related U.S. Application Data
(62) Division of application No. 09/872,686, filed on May 31, 2001.

(51) Int. Cl. G06F 17/30

(52) U.S. Cl. 707/9

(57) ABSTRACT

A calendar owner designates access privilege to his or her calendar for an individual user, a defined user group, or a user type at a time slot granularity level. A non-owner party attempts to access selective time slots of the calendar owner's calendar. The access privilege is checked at the time slot level. Both explicit grant as well as implicit grant, by virtue of either being affiliated with an authorized user group or having an authorized user type, are checked.

### BACKGROUND OF THE INVENTION

1. Field of the Invention

The present invention relates to the field of data processing. More specifically, the present invention relates to computer hosting of multi-user calendar systems, including in particular, controlling user access to the hosted calendars with at least time slot granularity.

2. Background Information

Computer hosted calendaring systems in general are known in the art. Examples of known calendar systems include client/server based systems such as Outlook and Lotus, available from Microsoft Corp of Redmond, Wash., and IBM of Armonk, N.Y., respectively, and web based calendar systems such as those offered by Microsoft Network (MSN) and Yahoo.

Typically, these systems provide to an individual user a computer maintained record of the individual user's event schedule, and data associated with each event in the schedule, arranged for viewing in a temporal presentation. Each event usually has three components, a starting time, an ending time, and a description, with the starting time and the ending time together defining an event time-slot. The temporal presentation is generally arranged according to a calendar. The calendar is generally arranged according to several selectable views that include a yearly view, a monthly view, a weekly view, a two-day view, and a daily view.

Further, these calendaring systems are typically hosted on networked computer systems. The networked calendaring system permits a calendar owner's calendar, whose events are maintained and/or stored by one computer system, to be accessed on another computer system functionally connected to the computer system that maintains and/or stores the calendar owner's calendar. In these networked calendaring systems, a calendar owner's calendar is generally maintained and stored on a server system, with the calendar owner, and other potential user's of the calendar, functioning as clients in relation to the server. Alternatively, the calendar owner's calendar may be maintained and stored in the calendar owner's computer, with other users functionally connected to the calendar owner's computer directly.

A computer hosted calendaring system is conventionally accessible by authorized users other than the calendar owner, who can read and/or write event data from and to the calendar owner's schedule. However, these calendaring systems provide to these authorized users an authorization for only the entire calendar owner's calendar (except for conventionally designated private events), rather than for uniquely defined time-slots for a read and/or a write operation. Moreover, these systems do not provide for a plurality of user groups or user types, with each user group/user type defined by a set of distinct authorized time-slots for a read and/or a write operation.

### SUMMARY OF THE INVENTION

Apparatuses and methods for controlling accesses to calendaring events in a computing system are disclosed. For each individual user, a defined user group, or an user type, the calendar owner may designate the time-slots in his or her calendar to which the user, users of the user group, and/or user type may have a time slot based read access, and/or a time slot based write access, to his or her calendar. The time slot based read access and the time slot based write access time-slots may be separately defined.

A non-owner party attempts to gain read and/or write access to the calendar owner's calendar at a time slot granularity level. The non-owner party is checked for access privilege at the time slot level. The access privilege at the time slot level may have been explicitly given to the non-owner party or implicitly given by virtue of the non-owner party's affiliation with an authorized user group or user type. If the non-owner party has been so given access privilege to the requested time slots, the non-owner party is accorded access to the requested time-slots.

### BRIEF DESCRIPTION OF THE DRAWINGS

The present invention will be described by way of exemplary embodiments, but not limitations, illustrated in the accompanying drawings. Identical numerals indicate the same elements throughout the figures.

FIG. 1 is an exemplary Owner Authorization menu (Long Version) presented to a calendar owner on a computer system display, according to one embodiment. A calendar owner uses the Owner Authorization menu to grant to a non-owner party, or non-owner parties having a group affiliation or a user type, read and/or write accesses to selective time slots of the owner's calendar.

FIG. 2 is an exemplary Quick Authorization menu for granting time slot based calendar access to a non-owner party by associating the non-owner party with a user type according to one embodiment.

FIG. 3 is the exemplary Owner Authorization menu of FIG. 1 in which both read and write access data for a time slot of the calendar owner's calendar has been entered for a user, a user group, or a user type.

FIG. 4 is an exemplary conventional monthly calendar with entries of a calendar owner's calendar, presented on a computer system display or alternatively printed.

FIG. 5 is an exemplary conventional two-day calendar for the days Thursday June 8, and Friday June 9, corresponding to the calendar of FIG. 4, presented on a computer system display or alternatively printed.

FIG. 6 is an exemplary monthly calendar display/print extracted from the calendar owner's monthly calendar portrayed in FIG. 4, for a non-owner party (having restricted read access), according to one embodiment.

FIG. 7 is an exemplary conventional two-day calendar display/print for the calendar owner, with entries that are consistent with the entries portrayed in FIG. 4 for an exemplary date June 12.

FIG. 8 is an exemplary conventional two-day calendar display/print for the calendar owner, with entries that are consistent with the entries portrayed in FIG. 4 for an exemplary date June 13.

FIG. 9 is an exemplary conventional two-day calendar display/print for the calendar owner, with entries that are consistent with the entries portrayed in FIG. 4 for an exemplary date June 15.

FIG. 10 is an exemplary two-day calendar display/print for the non-owner party (having restricted access), the calendar owner's June 12 calendar portrayed in FIG. 7, according to one embodiment.

FIG. 11 is an exemplary two-day calendar display/print for a non-owner party (having restricted access), the calendar owner's June 13 calendar portrayed in FIG. 7, according to one embodiment.

FIG. 12 is an exemplary two-day calendar display/print for a non-owner party (having restricted accesses), the calendar owner's June 15 calendar portrayed in FIG. 8, according to one embodiment.

FIG. 13 is an exemplary Guest menu for a non-owner party to access a calendar owner's calendar, to read from and/or write to the calendar owner's calendar, according to one embodiment.

FIG. 14 is an exemplary Guest Calendar Event Entry menu for a non-owner party to write into a calendar owner's calendar, according to one embodiment.

FIGS. 15a-15d and 16 are exemplary control data structures suitable for use to practice the present invention.

FIG. 17 is a flowchart portraying a method according to one embodiment, to grant a non-owner party read and/or write access to selected time slots of a calendar owner's calendar.

FIG. 18 is a flow chart portraying a method according to one embodiment, to associate a non-owner party with a user type.

FIG. 19 is a flow chart portraying a method according to one embodiment, to control access by a non-owner party to a calendar owner's calendar.

FIG. 20 is an exemplary computer system suitable for use to practice the present invention, according to an embodiment.

### DETAILED DESCRIPTION OF THE INVENTION

The present invention is directed toward a calendar system having time slot based control of non-owner party's access to a calendar owner's calendar. In the description to follow, various aspects of the present invention will be described. However, the present invention may be practiced with only some or all aspects of the present invention. For purposes of explanation, specific numbers, materials and configurations are set forth in order to provide a thorough understanding of the present invention. However, the present invention may be practiced without the specific details. In other instances, well known features are omitted or simplified in order not to obscure the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as is apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may include a general purpose computer selectively activated or reconfigured by a computer program stored in the computer. Such a computer program may be stored in a computer readable storage medium.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Various operations will be described as multiple discrete steps performed in turn in a manner that is most helpful in understanding the present invention, however, the order of description should not be construed as to imply that these operations are necessarily order dependent, in particular, the order the steps are presented. Furthermore, the phrase “in one embodiment” will be used repeatedly, however the phrase does not necessarily refer to the same embodiment, although it may.

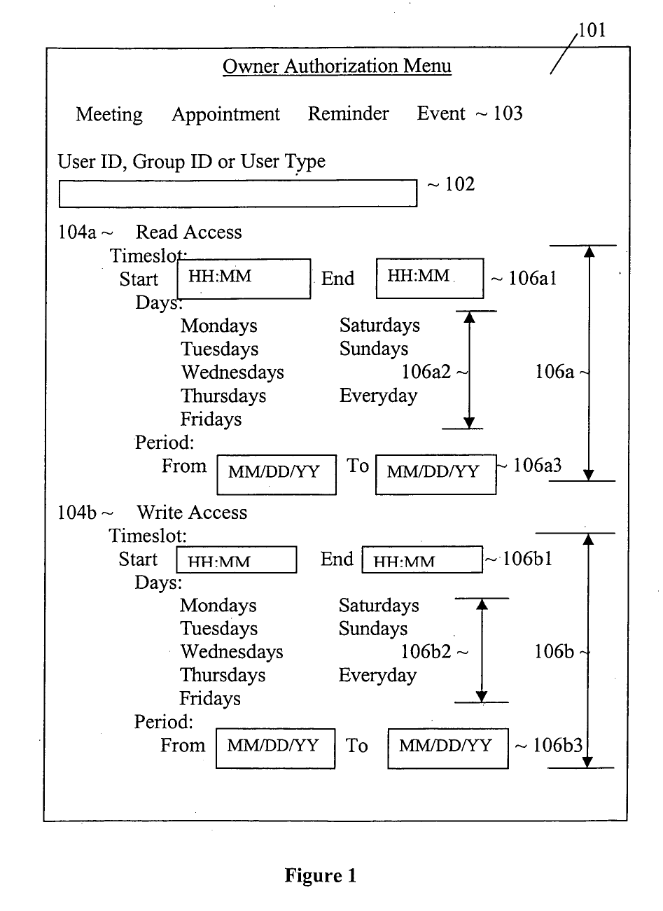

Referring now to FIG. 1, a calendar owner (or other party having access authority for the calendar, hereinafter calendar owner) may preferably call up an Owner Authorization menu (Long Version) 101 of the calendar system of the present invention on a computer display to give access to a non-owner party, non-owner parties of a user group, or a user type, to the owner's calendar on a time slot basis. For the purpose of this application, a non-owner party is a non-owner user of a computer system. Accordingly, for ease of description, a non-owner party may also simply be referred to as a user, hereinafter. A user group is a collective designation of a plurality of users, e.g. “Dept99” as a group identification may represent all users that are members of a “Department 99”. A user type is a characterization given to a plurality of users, e.g. “Teachers”, “Friends”, “Study Partners”, and so forth.

Typically, a non-owner party is identified by his or her system log-in ID. However, alternative identification means may be employed instead. Likewise, a user group is identified by a user group name or identification, typically given by a system administrator for the plurality of group members. As with user types, the present invention contemplates that a plurality of user types are pre-provided, however, a calendar owner may add to or subtract from the pre-provided user types. Provision of such facilities is well within the ability of those ordinarily skilled in the art; accordingly, these facilities will not be described.

As illustrated, the Owner Authorization menu 101 has a User data entry field 102 for designating a user, a user group, or a user type to be given an access status to the owner's calendar on a time slot basis. The user preferably selects the User data entry field 102, and subsequently enters the user, group, or user type identification, via a computer keyboard, with the entry subsequently displayed in the User data entry field 102.

For the illustrated embodiment, the Owner Authorization menu 101 also has a selection field 104a for designation (i.e. granting) of a read access status, and a selection field 104b for designation (i.e. granting) of a write access status 104b for a calendar time slot for an operational period. In one embodiment, the default access status for any non-owner party (group or user type) is no-access, but whatever access status that was previously selected for a non-owner party (group or user type), it is preferably maintained until the authorized access is changed. In order to give read access to the non-owner party (group or user type), the owner selects the read access selection field 104a, and in order to not give read access to the non-owner party (group or user type), the owner does not select the read access selection field 104a. Similarly, in order to give write access to the non-owner party (group or user type), the owner selects the write access selection field 104b, and in order to not give write access to the non-owner party (group or user type), the owner does not select the write access field 104b. The calendar owner selects both the read access selection field 104a and the write access selection field 104b, in order to give both a read and a write access to the non-owner party (group or user type), and the calendar owner does not select the read access field 104a and the write access field 104b, in order to not give either a read and a write access to the non-owner party (group or user type).

The Owner Authorization menu 101 has selection fields 106a and 106b for designation of the time-periods within the calendar owner's calendar, and the duration, for which the non-owner party (group or user type) is being given read access and write access, respectively. The read access and write access selection fields 106a and 106b preferably include time period selection fields 106a1 and 106b1 for designating the time periods. The read access and write access selection fields 106a and 106b preferably further include separate selection fields for designating recurrent access for each selected day of the week or everyday of the week 106a2 and 106b2, and separate fields for designating the duration for which the specifications apply 106a3 and 106b3.

The Owner Authorization menu 101 also has selection fields 103 for designation of event types, which may include exemplary event types of “meeting”, “appointment”, “reminder”, and “event”. The calendar owner may optionally select these event types in an embodiment of the present invention, to further restrict a non-owner party's access to the writing of specific event types, or the reading of specific event types, within the valid access time-slots, and for the specified duration.

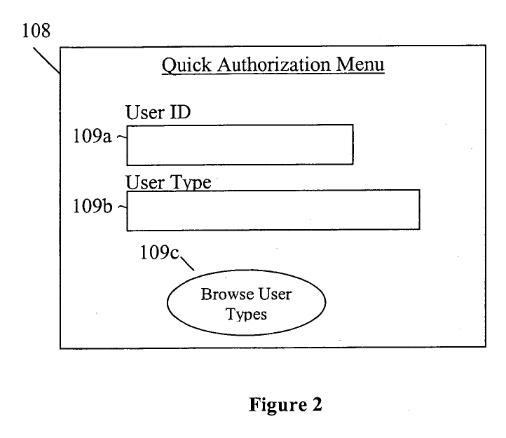

Referring now to FIG. 2, a Quick Authorization menu 108 of the calendar system of the present invention in accordance with one embodiment, is shown. Quick Authorization menu 108 enables a non-owner party be quickly granted access to selective time slots of a calendar owner's calendar for a pre-determined duration, by associating the non-owner party a user type. Upon associating the non-owner party with a user type, the non-owner party is implicitly granted the same access rights for the same time slots and duration, as the access rights previously granted to the user type.

The calendar owner preferably selects the User ID data entry field 109a, and subsequently enters the non-owner party's identification into User ID data entry field 109a. Thereafter, the calendar owner preferably selects the User Type data entry field 109b, and subsequently enters a user type in the User Type entry field 109b. As alluded to earlier, typically, the user type entered has been previously granted access to selective time slots of the calendar owner's calendar by way of the Owner Authorization menu 101 of FIG. 1. For the illustrated embodiment, a browse button 109c is also advantageously provided to facilitate the calendar owner in selecting a user type from pre-provided user types for entry into User Type entry field 109b.

In a preferred embodiment of the present invention, only a calendar owner may enter data into this menu. A specific example of the utility of this aspect of the present invention is a calendar owner first assigning an access status for selective time slots to a user type “teachers” using Owner Authorization menu 101. Then, the calendar owner may grant access to his/her teacher “Ann” by entering the name “Ann” in User data entry field 109a of Quick Authorization menu 108, and associating the name “Ann” with the user type “teacher” (entered in User Type field 109b). As a result, non-owner party “Ann” is granted the same access for the same selective time slots and duration previously defined for all “teachers”.

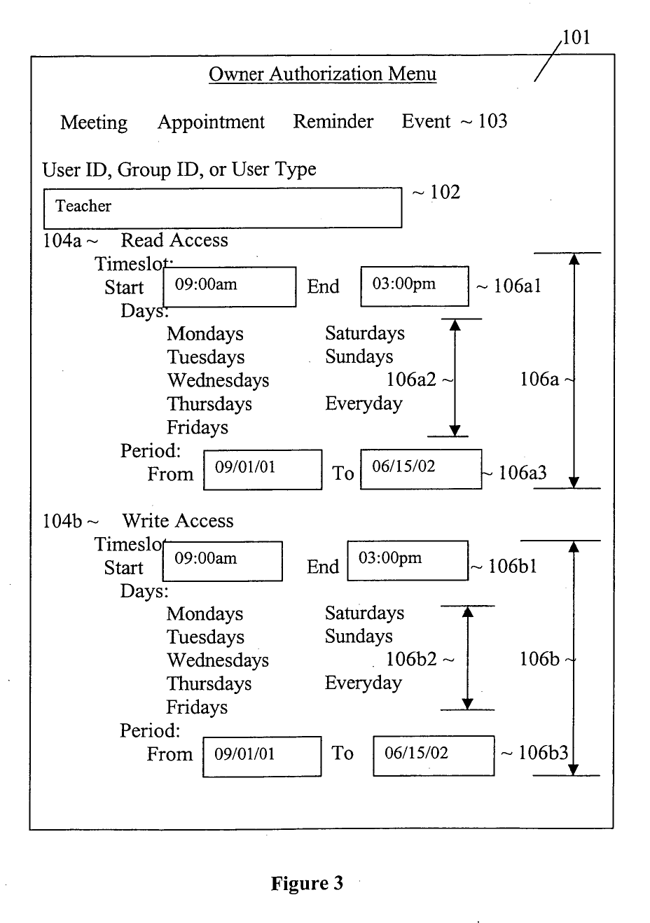

Referring now to FIG. 3, a calendar owner has entered data into the Owner Authorization menu 101 described with reference to FIG. 1. In this exemplary Owner Authorization menu data entry, a calendar owner has granted both a read access and a write access to users of the “Teacher” user type, for the time slots between 9:00 a.m.-3:00 p.m. on weekdays (Monday-Friday), from Sep. 1, 2001 to Jun. 15, 2002. This is an example illustrative of the utility and novelty of the present invention, wherein a calendar owner may selectively grant both, or either, a read and write access for different selectively time-periods for different user groups/types for a specified duration. In the example portrayed, the entries are consistent with a student calendar owner granting both a read access and a write access for his or her calendar to any non-owner user subsequently identified as his/her teacher, during, and only during, the traditional time-slots of the traditional school day (for the coming academic year). Other useful non-owner parties are, for instance, social friends having calendar access on Friday and Saturday nights, and study group members having calendar access on weekday nights, for also the coming school year or a different duration, including an indefinite duration.

In User data entry field 102, the calendar owner has entered the user type identifier “Teacher” as the identification of the user type to have access to the user's calendar. The calendar owner has designated in read access field 104a, a read access, and in write access field 104b, a write access, to users of the user type “Teacher”. In the read access day of the week selection field 106a1, the calendar owner has selected Mondays, Tuesdays, Wednesdays, Thursdays, and Fridays, thus giving to all “teachers” a read access to the calendar owner's calendar for each day Monday-Friday. In the duration selection field 106a3, the calendar owner has specified “Sep. 1, 2001 through Jun. 15, 2002” as the duration the above described read access authorization applies. In the write access day of the week selection field 106b1, the calendar owner has selected Mondays, Tuesdays, Wednesdays, Thursdays, and Fridays, thus giving to all “teachers” a write access to the calendar owner's calendar for each day Monday-Friday. In the write access time-period selection field 106b3, the calendar owner has specified “Sep. 1, 2001 through Jun. 15, 2002” as the duration the above described write access authorization applies.

Thus, the calendar owner, by entering data into the exemplary Owner Authorization menu 101, has given to all “teachers” both a read access to his/her calendar for each day Monday-Friday, from 9:00 a.m.-3:00 p.m., and a write access for each day Monday-Friday, from 9:00 a.m.-3:00 p.m., for the coming school year running from Sep. 1, 2001 through Jun. 15, 2002.

As described earlier, subsequently, the calendar owner may quickly grant the same access rights to specific teachers by identifying specific non-owner parties as having the user type “teachers” using Quick Authorization menu 108 earlier described. For example, using Quick Authorization menu 108, the calendar owner may grant the same access rights to a Mrs. Moore or Mr. Smith, by identifying Mrs. Moore and Mr. Smith as “Teachers”.

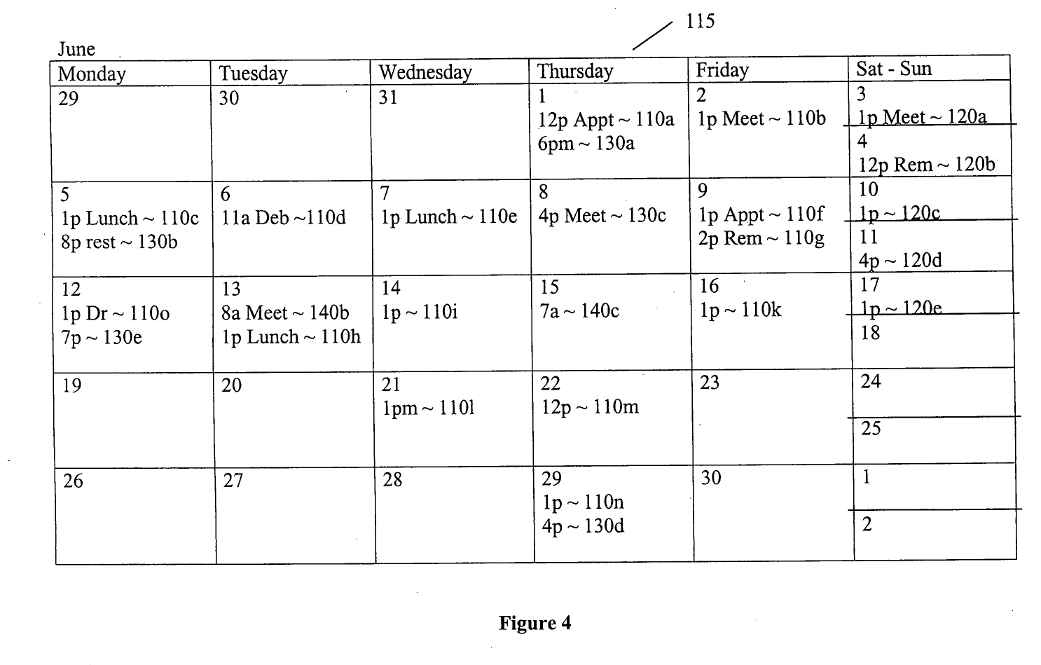

Referring now to FIG. 4, a conventional exemplary monthly calendar 115 displays a calendar owner's time-slot entries for each day of an exemplary month. The calendar displays for each day, the beginning time for each time-slot entry. It is noted that calendar 115 indicates time entries for each day Thursday June 1, through Saturday June 17, as well as Wednesday June 21, Thursday June 22, and Thursday June 29. With specific exemplary reference to Thursday June 1, the calendar 115 indicates two time-slot entries, the first at 12:00 p.m., and the second at 6:00 p.m., and with specific exemplary reference to Friday June 9, the calendar 115 indicates one time-slot entry beginning at 1:00 p.m.

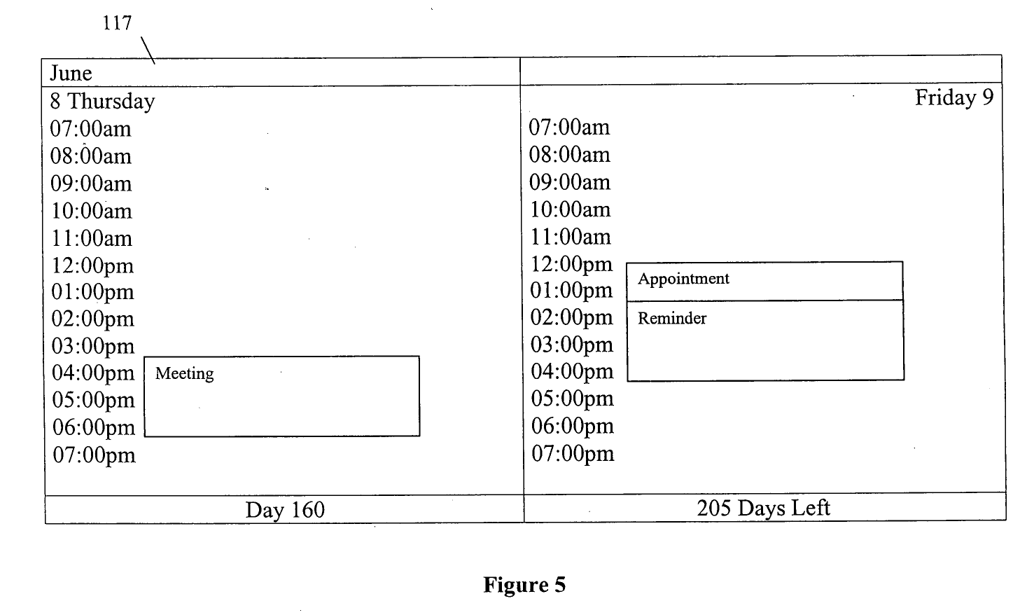

Referring to FIG. 5, a conventional exemplary two-day calendar 117 for Thursday June 8, and Friday June 9, corresponds to the entries in the monthly calendar 115 portrayed with reference to FIG. 4. The two-day calendar 117 displays that the Friday June 9, time-slot entry portrayed in monthly calendar 115 is for a time beginning at 1:00 p.m. and ending at 4:00 p.m.

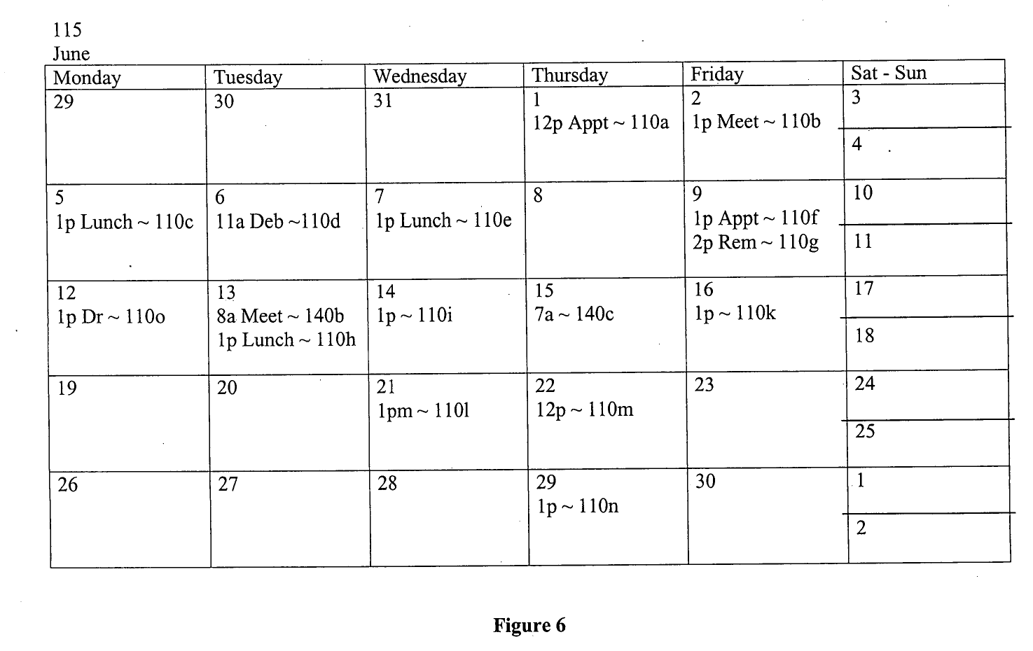

Referring to FIG. 6, a preferred embodiment of a non-owner party's view 135 corresponding to the calendar owner's calendar 115. The non-owner party has a restricted read access for the calendar owner's calendar 115 for the time-slots Mondays-Fridays, 9:00 a.m.-3:00 p.m. only. The exemplary read access time-slots are consistent with the entries portrayed on the Owner Authorization menu 101 with reference to FIG. 3. In calendar 135, the only data displayed from calendar owner's calendar 115 is the data for time-slots Mondays-Fridays, 9:00 a.m.-3:00 p.m., corresponding to the exemplary non-owner party's authorized read access time slots. Thus, with reference to both FIGS. 3 and 5, the entries for Mondays-Fridays, 3:00 p.m.-9:00 a.m., and all day Saturdays and Sundays, have been omitted from the calendar owner's calendar 115 for presentation of the calendar for this particular non-owner party.

The entries 110a-o of FIG. 4 fall fully within the time-slots Mondays-Fridays, 9:00 a.m.-3:00 p.m., and are displayed in the restricted read access calendar 135 portrayed in FIG. 6. The entries 120a-e of FIG. 4, for all Saturdays and Sundays, are not within the time-slots Mondays-Fridays, 9:00 a.m.-3:00 p.m., and are not displayed in the restricted read access calendar 135 portrayed in FIG. 6. The entries 130a-e of FIG. 4, which fall outside the read access period of 9:00 a.m.-3:00 p.m. for Mondays-Fridays, are also not displayed in the restricted read access calendar 135 portrayed in FIG. 6.

The time-slot entries that fall only partially within the non-owner party read access time-slots are preferably portrayed in the non-owner party's calendar with the time-slots falling within the valid non-owner party read access time-slots displayed (or printed for a printed calendar), but without the descriptive information otherwise associated with a time-slot entry, and the time-slots falling outside of the valid non-owner party read access time-slots not displayed (or printed).

Thus, referring to FIG. 4, time-slot entries 140a-c are portrayed on the conventional calendar owner's monthly calendar as beginning at 1:00 p.m. on June 12, with descriptive data printed; as beginning at 8:00 a.m. on June 13, with descriptive data printed; and beginning at 7:00 a.m. on June 15, with no descriptive data printed; for entries 140a, 140b, and 140c respectively.

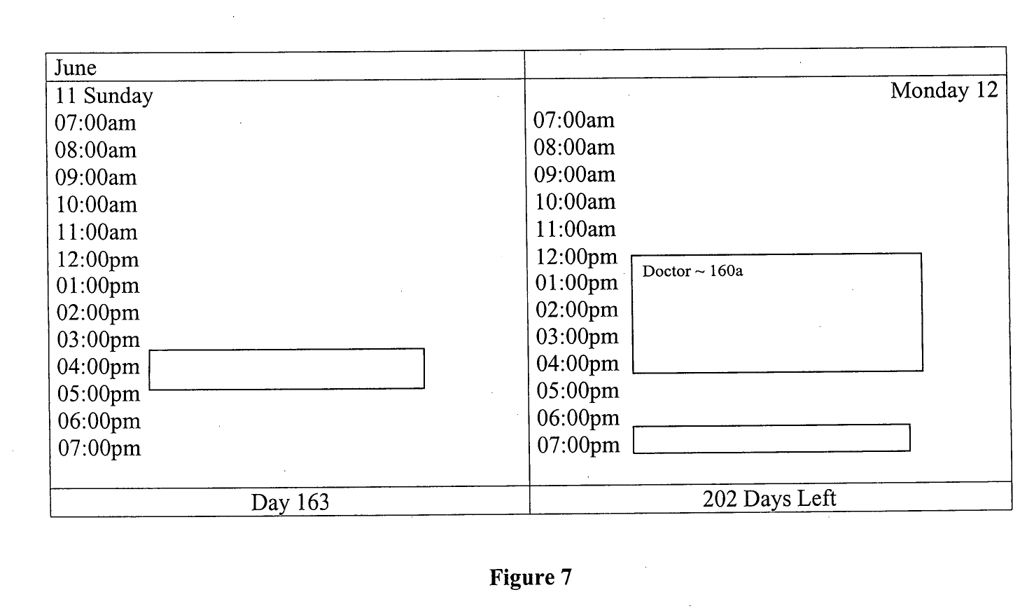

Referring to FIG. 7, the conventional calendar owner's two-day calendar for June 12, portrays the entry 140a beginning at 1:00 p.m. in the monthly calendar, as spanning the time-period 1:00 p.m.-5:00 p.m. and having an exemplary descriptive data “DOCTOR” 160a.

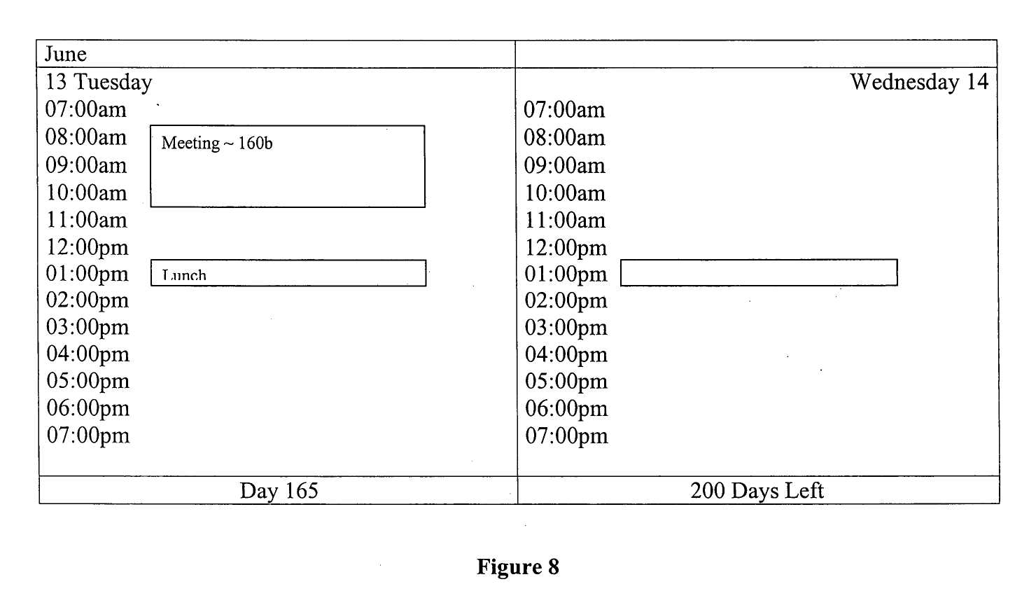

Referring to FIG. 8, the conventional calendar owner's two-day calendar for June 13, portrays the entry 140b beginning at 8:00 a.m., as spanning the time-period 8:00 a.m.-10 a.m. and having an exemplary descriptive data “MEETING” 160b.

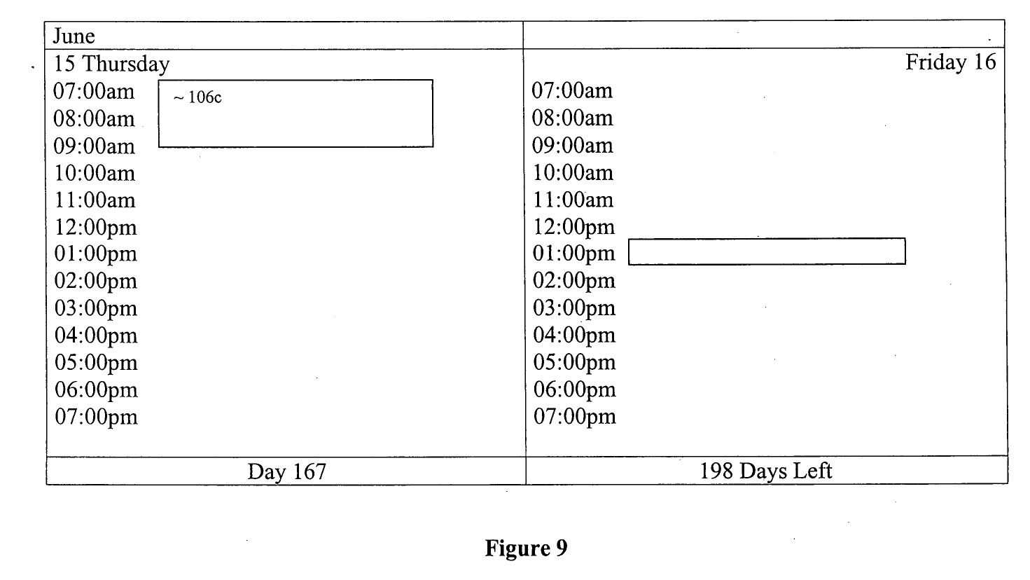

Referring to FIG. 9, the conventional calendar owner's two-day calendar for June 15, portrays the entry 140c beginning at 7:00 a.m., as spanning the time-period 7:00 a.m.-10:00 a.m. 160c.

Again referring to FIG. 6, the second party's preferred embodiment exemplary monthly calendar for June 12 portrays the entry 140a as time entry 150a beginning at 1:00 p.m. and having no descriptive data printed. For June 13, the entry 140b is portrayed as time entry 150b beginning at 9:00 a.m., rather than 8:00 a.m., and having no descriptive data printed. For June 15, the entry 140c is portrayed as time entry 150c beginning at 9:00 a.m. and having no descriptive data printed.

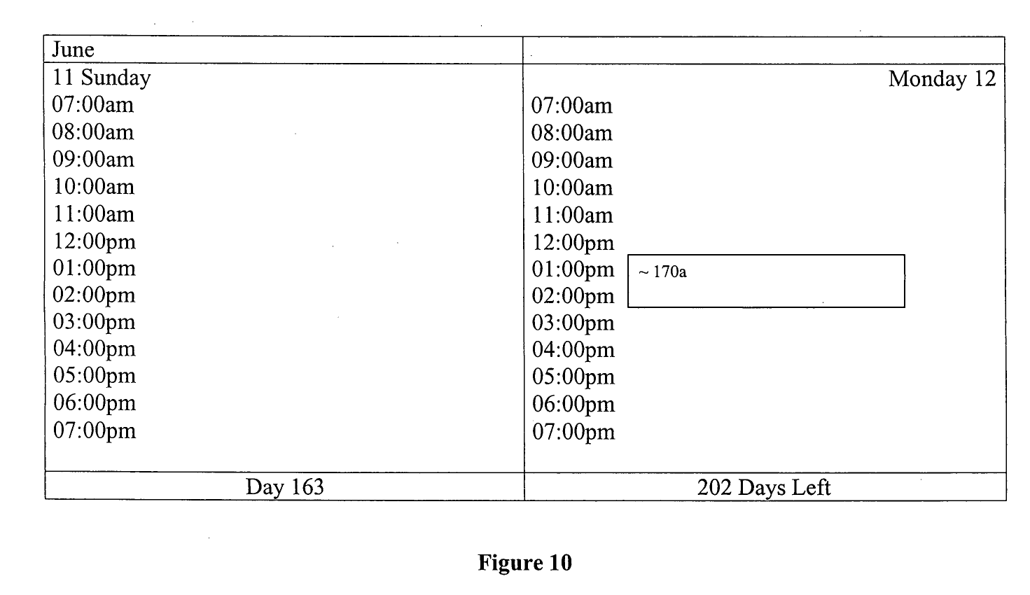

Referring to FIG. 10, the non-owner party's preferred embodiment exemplary two-day calendar for June 12 portrays the FIG. 7 time entry 160a, spanning the time range 1:00 p.m.-5:00 p.m. and having an associated exemplary descriptive data “Doctor”, as a time entry 170a spanning the time range 1:00 p.m.-3:00 p.m., so as to be fully within the bounds of the second party's valid read access times 9:00 a.m.-3:00 p.m., and having no associated descriptive data.

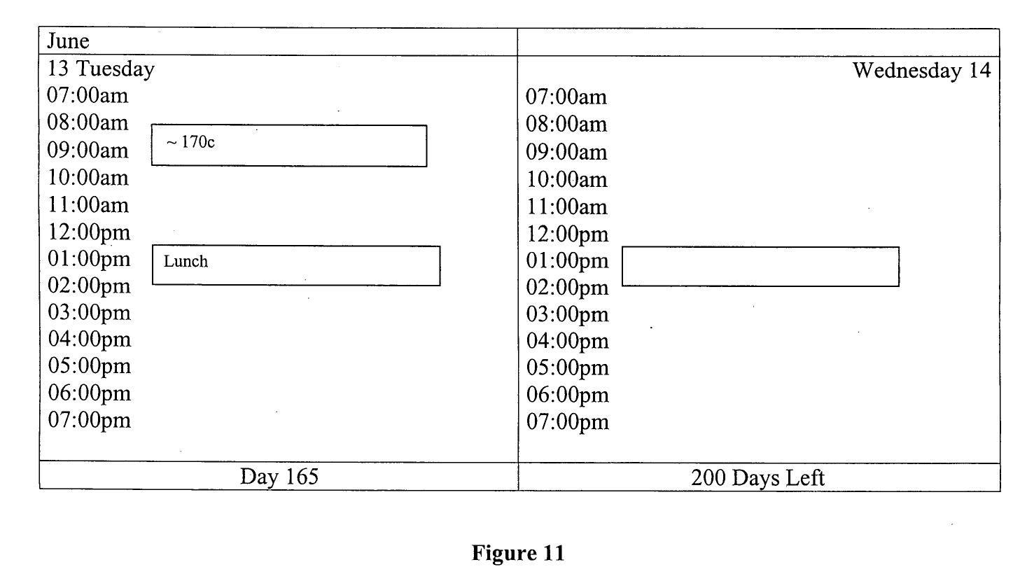

Referring to FIG. 11, the non-owner party's preferred embodiment exemplary two-day calendar for June 13 portrays the FIG. 8 time entry 160b, spanning the time range 8:00 a.m.-10:00 a.m. and having an associated exemplary descriptive data “MEETING”, as a time entry 170b spanning the time range 9:00 a.m.-10:00 a.m., so as to be fully within the bounds of the non-owner party's valid read access times, and having no associated descriptive data.

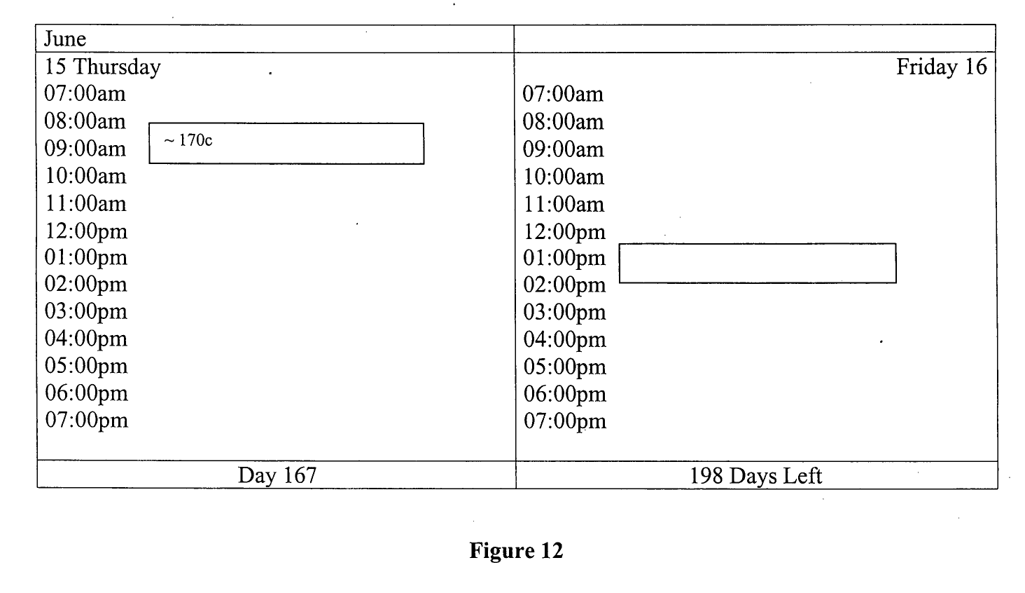

Referring to FIG. 12, the non-owner party's preferred embodiment exemplary two-day calendar for June 15 portrays the FIG. 9 time entry 160c, spanning the time range 7:00 a.m.-10:00 a.m. and having no associated descriptive data, as a time entry 170c spanning the time range 9:00 a.m.-10:00 a.m., so as to be fully within the bounds of the non-owner party's valid read access times, and having no associated descriptive data.

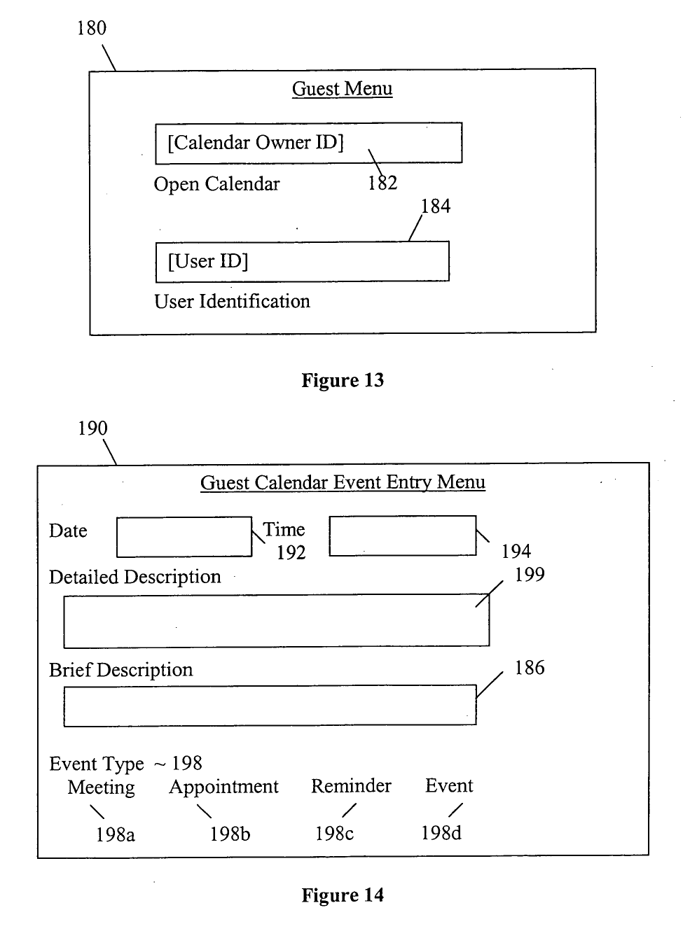

Referring to FIG. 13, a non-owner party user gains both read and/or write access to the calendar owner's calendar by preferably entering appropriate data into a Guest Access menu 180. The non-owner party selects and enters in the Open Calendar data entry field 182 an identifier of the calendar he or she is attempting to access. This identifier may be an identifier of the calendar owner. The non-owner party also preferably selects and subsequently enters into the User ID data field 184, his or her identifier.

As alluded to earlier, the user may have been explicitly given access to selected time slots of the calendar owner's calendar, or implicitly given access, by virtue of his or her membership with a group or user type previously attributed to the user.

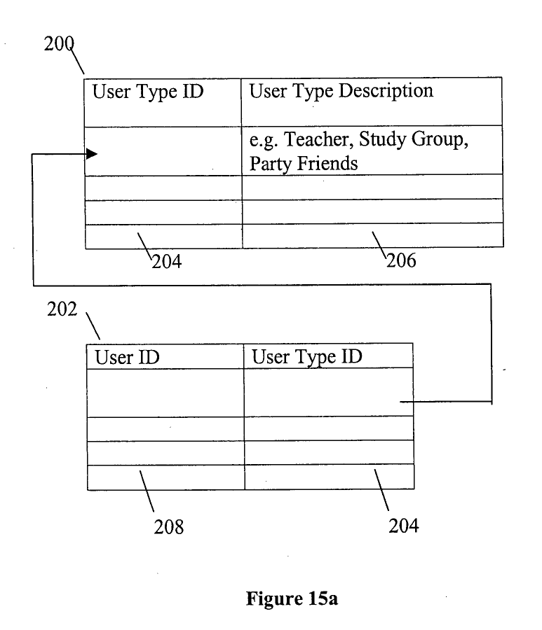

Referring to FIG. 14, the exemplary Guest Calendar Event Entry menu 190 includes the data fields appropriate for a non-owner party (having appropriate write accesses) to creation, edit, and/or delete entries of a calendar owner's calendar. It is specifically contemplated that this data may include the event date 192, beginning and ending time 194, brief description 196, event type 198 including an exemplary appointment 198a, meeting 198b, event 198c, and reminder 198d, and detailed description 199. If the non-owner party requesting access to the calendar owner's calendar does not have the appropriate write access, in one embodiment, the present invention displays for the non-owner party a corresponding notification.

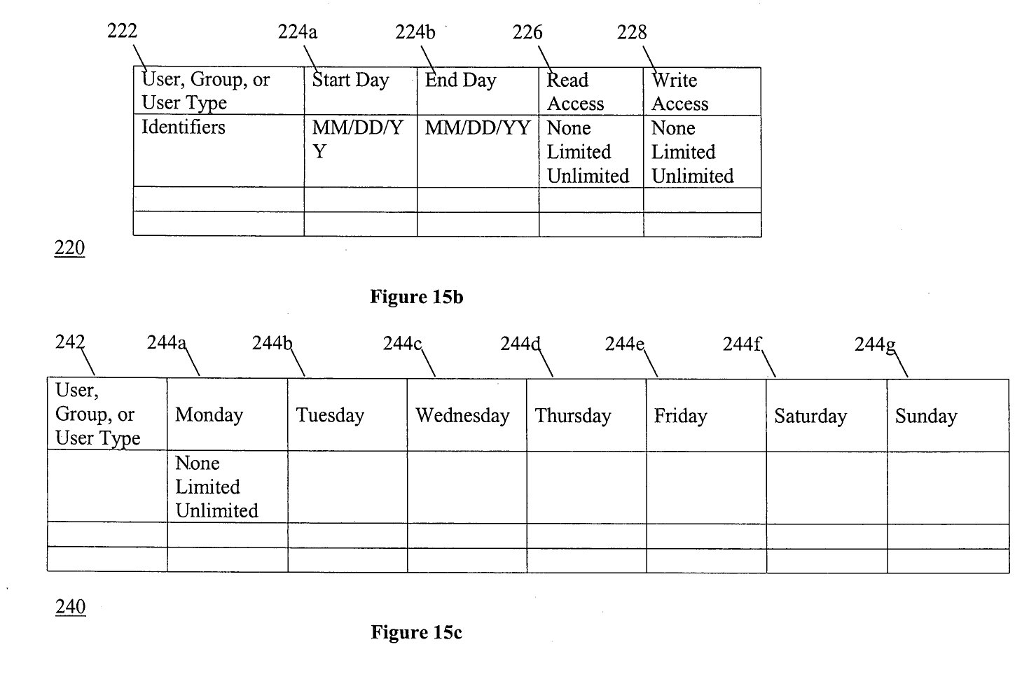

Referring now to FIGS. 15a-15d and 16, wherein a number of control data structures suitable for use to practice the present invention are shown. Illustrated in FIG. 15a are tables/view 200a and 200b, which may be employed to store the user type descriptions 206, including their identifiers 204, and the users 208 attributed with the various user types (represented by their identifiers) 204, respectively. Illustrated in FIG. 15b is table/view 220 suitable for use to track summaries of the accesses granted to the various users, user groups or user types. As illustrated, for each explicitly granted user, a user group, or a user type, its identifier 222 is tracked. Further, the starting and ending days 224a-224b of the specified duration, as well as the nature of the read and write accesses granted 226 and 228, if any, are tracked. The tracking may denote for each of the read and write accesses, either no access has been granted, limited access has been granted or unlimited access has been granted.

FIGS. 15c and 15d illustrate two exemplary tables/views 240 and 260 suitable for use to track the additional details, when limited access are granted for either read or write to a user, a user group or a user type. For each user, user group, or user type 242, having limited read/write access, table/view 240 tracks whether no access, limited access or unlimited access has been granted for each day of the week, Monday, Tuesday, Wednesday, Thursday, Friday, Saturday and Sunday 244a-244g. For each user, user group or user type 262, having been granted limited read/write access for a weekday, table/view 260 tracks the limited access granted, including the day of the week 264, whether the access is for read, write or both 266, and the starting and ending time of the particular limited access time slot, 268a-268b.

FIG. 16 illustrates an exemplary working data structure that may be constructed in memory during operation, when a user request access to a calendar owner's calendar. Exemplary working data structure 280, includes a root segment having the identification of the user 282, a field for each of the weekdays 284a-284g. Within each field 284a-284g, an annotation is made denoting whether no access has been granted for the weekday, or a pointer to the first time slot, if access to at least one of time slots of the weekday is authorized. Each pointer from the root segment points to a link list, e.g. list 286 or 288 listing the authorized time slots of the particular weekday. Accordingly, a user's authorization for a particular requested time slot may be efficiently checked.

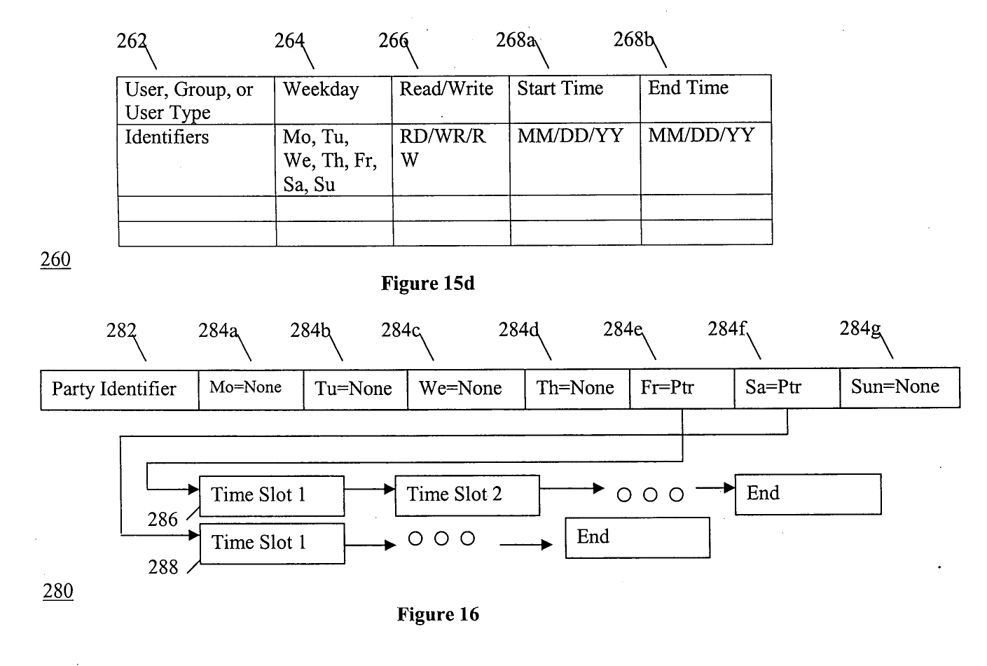

Referring now to FIG. 17, wherein a flow chart illustrating a method for supporting the employment of the Owner Authorization menu of FIG. 1 to grant access to selective time slots of a calendar owner's calendar to a user, a user group, or a user type is shown. As illustrated, upon invocation, the calendar software reads the identification of the user, the user group or the user type, the read/write access selection, the corresponding time slot selections and the duration inputted by the “calendar owner”, block 302. Thereafter, the calendar software determines if any changes have been made to the information read, block 304. For the illustrated embodiment, the calendar software is assumed to maintain the last known state of the information (retrieving the information from the control structure at invocation, if necessary).

If changes have been made to the information read, the calendar software further determines if changes have been made to read access granted to the user, the user group or the user type, block 306. If changes have been made to the read access granted to the user, the user group or the user type, the calendar software updates the control data structures, e.g. the earlier described exemplary control data structures, down to the time slot granularity level, if necessary, block 308.

If no changes have been made to read access granted to the user, the user group or the user type, the calendar software further determines if changes have been made to write access granted to the user, the user group or the user type, block 310. If changes have been made to the write access granted to the user, the user group or the user type, the calendar software updates the control data structures, e.g. the earlier described exemplary control data structures, down to the time slot granularity level, if necessary, block 312.

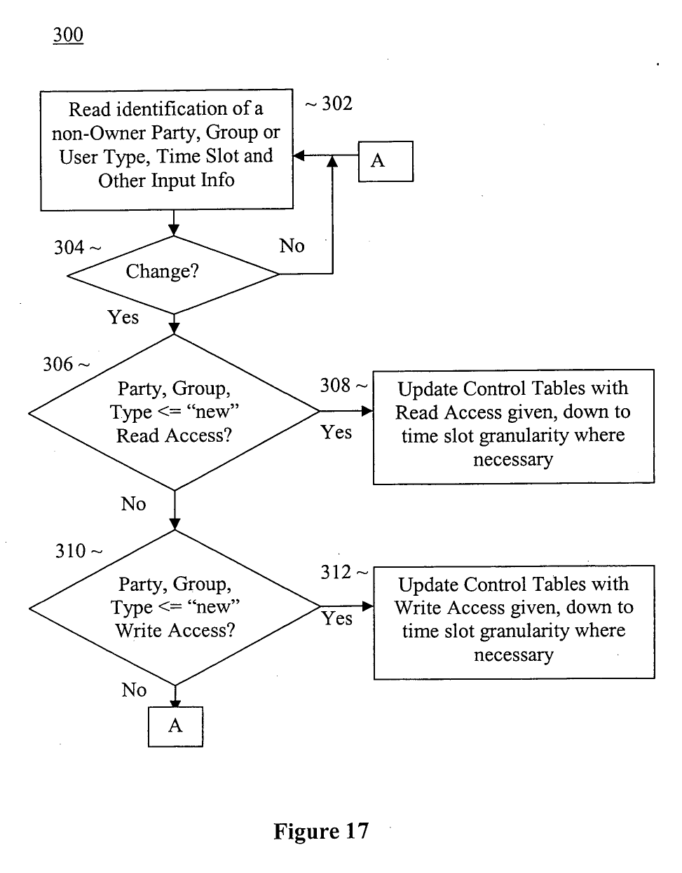

Referring now to FIG. 18, wherein a flow chart illustrating a method for supporting the employment of the Quick Authorization menu of FIG. 2 to grant access to selective time slots of a calendar owner's calendar by attributing a user type to a user is shown. As illustrated, upon invocation, the calendar software reads the identification of the user, and the user type inputted by the “calendar owner”, block 322. Thereafter, the calendar software updates the control data structures, e.g. the earlier described exemplary control data structures, down to the time slot granularity level, if necessary, block 324.

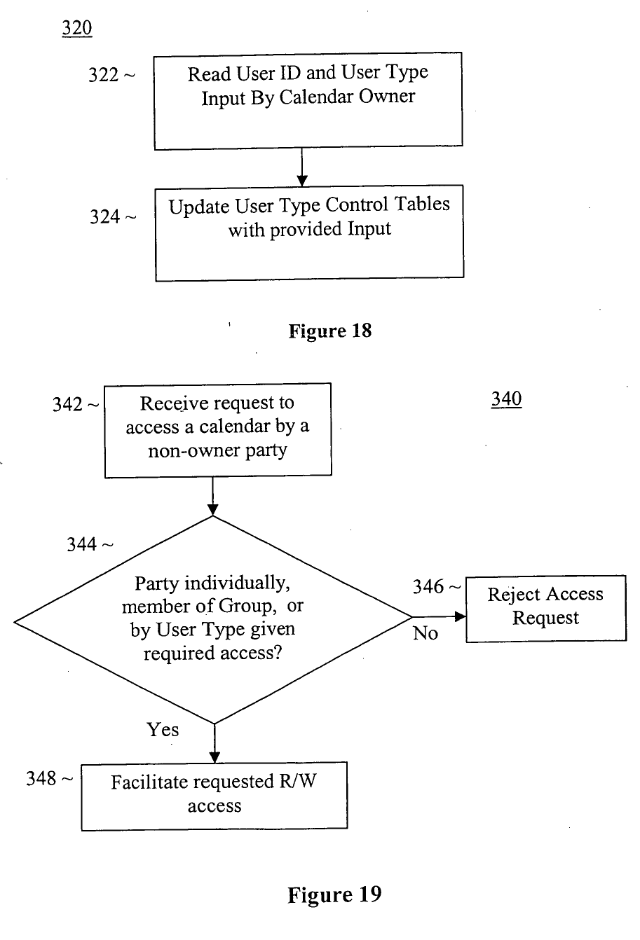

Referring now to FIG. 19, wherein a flow chart illustrating a method for controlling access by a non-owner party to a calendar owner's calendar in accordance to with the time slot based access granted employing the menus of FIGS. 1 and 2 is shown. As illustrated, upon receipt of a request or an attempt by a non-owner party to access a time slot or a number of time slots of a calendar owner's calendar, block 342, the calendar software determines whether the non-owner party has been granted the right to access the requested time slot or time slots, block 344. In one embodiment, the calendar software determines all the time slots the non-owner party have been given access rights, whether they are given explicitly or implicitly by virtue of the non-owner party's membership with a group or by virtue of an attributed user type. As described earlier, the non-owner party's group membership may be obtained e.g. from an operating system, and the non-owner party's user type, if applicable, may be obtained e.g. from control tables 202 of FIG. 15a. For the embodiment, the requested access is rejected 346 or facilitated 348 based on the union of all the rights granted. In other words, the present invention contemplates that the non-party owner may have been granted access rights for certain time slots by virtue of his/her group membership or user type, and thereafter, the calendar owner further supplements the defaulted time slot set with additional authorizations for other time slots not generally granted to other members of the group or user type.

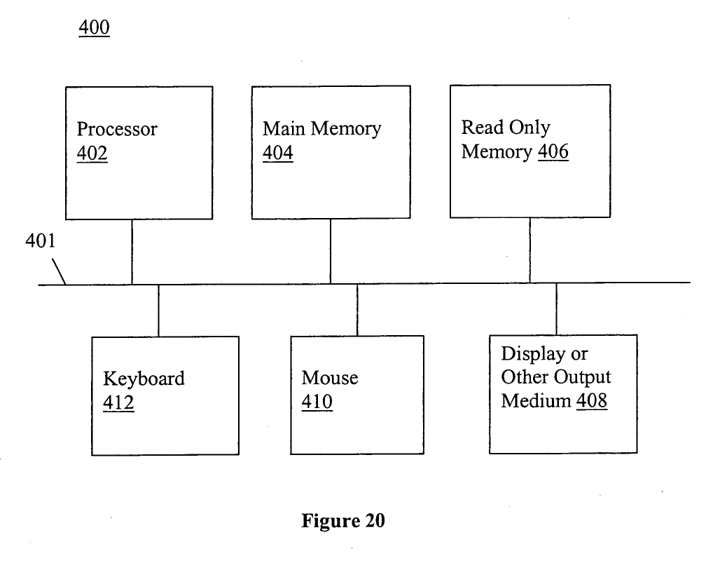

Referring to FIG. 20, computer system 400 comprises bus 401, or other communication device for communicating information, and processor(s) 402 coupled with bus 401 for processing information. Computing system 400 further comprises main memory 404, a computer readable media that is commonly random access memory (RAM) or other dynamic storage device, coupled to bus 401 for storing information and instructions for execution by processor 402. Main memory 404 is used to store temporary variables or other intermediate information during execution of instructions by processor 402. Computer system 400 also comprises a read only memory (ROM) media and/or other static storage device 406 coupled to bus 401 for storing working copies of the working information and instructions implementing the present invention for processor(s) 402. Data storage device 406, another computer readable media, is coupled to bus 401 for storing “permanent copies” of the working information and the implementing instructions, and can be such exemplary computer readable media as magnetic disk, and/or an optical disk and corresponding drives. Display 408 is coupled to bus 401 for displaying data generated by the processors 402, and mouse 410, or other exemplary selecting or pointing device, and keyboard 412, each coupled to bus 401, are used to input data into the processor 402.

While certain exemplary embodiments have been described and shown in the accompanying drawings, it is to be understood that these embodiments are merely illustrative of and not restrictive of the broad invention. For example, the present invention is presented with reference to a plurality of displays and data input menus. These displays and data input menus are exemplary and illustrative of an embodiment of the present invention, and how the present invention can be used. It is understood that the displays and menus required by the present invention and presented herein for exemplary purposes are adaptable to conform to the data display and entry characteristics of other calendaring systems. The present invention is not limited to the specific constructions and arrangements shown and described, and alternative embodiments will become apparent to those skilled in the art to which the present invention pertains without departing from the scope of the present invention. The scope of the present invention is defined by the appended claims rather than the foregoing description.

1-17. (canceled)

18. An article of manufacture including one or more computer-readable media having stored thereon a plurality of programming instructions for implementing a computer-hosted calendar to be executed by at least one processor that when executed perform the following operations:
designating to a user of said calendar a specific access ability based on a characteristic of said user; and
processing a request to access said calendar based on said characteristic-based designated access ability.

19. The article of manufacture defined in claim 18, wherein said specific access ability includes an ability to perform at least one of reading data from only specific read-data time-slots of said calendar, and writing data into only specific write-data time-slots of said calendar; and wherein said process includes at least one of retrieving data for said user in conformance with said read-data time-slot specification, and updating said calendar in conformance with said write-data time-slot specification.

20. The article of manufacture defined in claim 18 wherein said operations further include before said designating operation,
associating with each of at least one user characteristic an access ability to said calendar, with each associated access ability including an ability to at least perform one of reading data only from specific read-data time-slots of said calendar, and writing data only into specific write-data time-slots of said calendar; and wherein said designated specific access ability includes the associated access ability corresponding to said characteristic of said user.

21. The article of manufacture defined in claim 18 wherein said operations include reading from an administrative user of said calendar said characteristic and the specific access ability to be designated before said designating operation.

22. The article of manufacture defined in claim 18 wherein said operations include reading from an owner of said calendar said characteristic and said specific access ability to be designated.

23. The article of manufacture defined in claim 18 wherein said characteristic includes one of an individual identifier, a group affiliation, and a user type.

24. The article of manufacture defined in claim 18 wherein said specific access ability includes an ability to read data from specific read-data time-slots of said calendar, and wherein if said calendar includes at least one event that spans a plurality of time-slots, with only some of which being accessible read-data time-slots, and each of said at least one event including both time-slot data and descriptive data, then said processing including reading data from said specific read-data time-slots and omitting said descriptive data.

25. The article of manufacture defined in claim 18 wherein said operations include reading from an owner of said calendar, before said designating operation, a first characteristic and an associated first specific access ability, and at least one second characteristic that is assigned the specific access ability associated with said first characteristic, and wherein if said user characteristic is equivalent to one of said at least one second characteristic, said user is designated said first access ability as its specific access ability.

26. The article of manufacture defined in claim 18 wherein said processing includes, if said designated specific access ability includes an ability to write into said calendar for specific write-data time-periods, processing a request to write data into said calendar for said write-data time-slots, and if said designated specific access ability includes an ability to read data from said calendar for specific read-data time-slots, processing a request to read data from said calendar for said read-data time-slots.

27. The article of manufacture defined in claim 18 wherein said specific access ability includes an ability to perform at least one of reading data from only specific event type time-slots of said calendar, and writing data into only specific event type read-data time-slots of said calendar; and wherein said processing includes at least one of retrieving data for said user in conformance with said read-data time-slot specification, and updating said calendar in conformance with said write-data time-slot specification.

28. The article of manufacture defined in claim 18 wherein said processing further includes said user updating said calendar with specified event type data.

29. An apparatus comprising:
a storage medium having stored therein a plurality of programming instructions designed to enable the apparatus, when the programming instructions are executed, to receive an input for a first of a plurality of time-slots of a first party's calendar from a second party, the first and second parties being different parties, and the second party being associated with a group affiliation or a user type or both, and the group affiliation or user type or both having a plurality of access privileges for the time-slots of the first party's calendar, wherein the plurality of access privileges are defined for specific time-slots, and to process said received input in accordance with the access privilege of the second party's associated group affiliation or user type or both for the first time-slot; and
a processor coupled to the storage medium to execute the plurality of programming instructions.

30. An apparatus comprising:
a storage medium having stored therein a plurality of programming instructions designed to enable the apparatus, when the programming instructions are executed, to designate a plurality of access privileges to a plurality of time-slots of a first user's calendar for a user group or user type or both, wherein the plurality of access privileges are defined for specific time-slots, to determine that a second user is a member of said user group or type or both, and to grant or deny access to a first time-slot of the plurality of time-slots to said second user in accordance with the access privilege for the first time-slot of the user group or type or both determined for said second user; and
a processor coupled to the storage medium to execute the plurality of programming instructions.
